(19) United States
(12) Patent Application Publication
(10) Pub. No.: US 2024/0355098 A1
(43) Pub. Date: Oct. 24, 2024

(54) IMAGE DATA PROCESSING APPARATUS AND METHOD

(71) Applicants: The University Court of the University Of Edinburgh, Edinburgh (GB); CANON MEDICAL SYSTEMS CORPORATION, Tochigi (JP)

(72) Inventors: Xiao LIU, Old College, Edinburgh (GB); Sotirios A. TSAFTARIS, Old College (GB); Alison Q. O'NEIL, Bonnington Bond Edinburgh (GB); Pedro SANCHEZ, Old College (GB)

(73) Assignees: The University Court of the University Of Edinburgh, Edinburgh (GB); CANON MEDICAL SYSTEMS CORPORATION, Tochigi (JP)

(21) Appl. No.: 18/626,419

(22) Filed: Apr. 4, 2024

Related U.S. Application Data
(60) Provisional application No. 63/497,372, filed on Apr. 20, 2023.

(51) Int. Cl. G06V 10/774; G06V 10/26

(52) U.S. Cl. CPC G06V 10/774; G06V 10/26; G06V 2201/031; G06V 2201/034

(57) ABSTRACT

A medical image processing apparatus includes a memory storing training medical images, each annotated with respective weak supervision annotation information relating to at least one object represented in the training medical image, the at least one object comprising an anatomical object, a pathology, or a medical device; and processing circuitry configured to use the plurality of training medical images to train a deep learning network to perform a task, wherein the training of the deep learning network includes training a compositional latent representation comprising a plurality of kernels, wherein the training of the compositional latent network includes using the weak supervision annotation information to provide weak supervision of the training of the computational latent representation, thereby guiding the compositional latent representation towards a representation in which different ones of the kernels are representative of different objects, the different objects comprising at least one anatomical object, pathology, or medical device.

### CROSS-REFERENCE TO RELATED APPLICATIONS

The present application is based on and claims priority to provisional Application No. 63/497,372, filed on Apr. 20, 2023, the entire contents of which are incorporated herein by reference.

### FIELD

Embodiments described herein relate generally to a method and apparatus for processing image data, for example a method and apparatus for training a deep learning network for medical image processing.

### BACKGROUND

Medical image segmentation can play a crucial role in diagnosing diseases. To train deep models for accurate and automatic medical image segmentation, a significant amount of labelled data is typically required. However, fully annotating the segmentation masks for imaging data is very computationally expensive.

For example, when segmenting structures in cardiac MRI (magnetic resonance imaging) data, full annotation of one patient's cardiac MRI data typically requires many hours (even days) of work from an experienced doctor.

### SUMMARY

In a first aspect, there is provided a medical image processing apparatus comprising a memory storing a plurality of training medical images, each annotated with respective weak supervision annotation information and processing circuitry configured to use the plurality of training medical images to train a deep learning network to perform a task. The training of the deep learning network comprises training a compositional latent representation comprising a plurality of kernels.

The weak supervision annotation information relates to at least one object represented in the training medical image. The at least one object may comprise at least one anatomical object. The at least one anatomical object may comprise at least one organ. The at least one anatomical object may comprise at least one organ sub-structure. The at least one object may comprise at least one pathology. The at least one object may comprise at least one medical device.

The training of the compositional latent network comprises using the weak supervision annotation information to provide weak supervision of the training of the computational latent representation. The training may thereby guide the compositional latent representation towards a representation in which different kernels are representative of different objects. The different objects may comprise at least one anatomical object. The different objects may comprise at least one pathology. The different objects may comprise at least one medical device.

The kernels may be von Mises Fisher kernels.

Any suitable number of kernels may be provided. For example, the plurality of kernels may consist of 12 kernels. The plurality of kernels may comprise at least 5 kernels. The plurality of kernels may comprise at least 10 kernels. The plurality of kernels may comprise fewer than 20 kernels. The plurality of kernels may comprise fewer than 15 kernels.

Any suitable variance of a distribution of each kernel may be provided, for example, a variance of a distribution of each kernel may be 30. A variance of a distribution of each kernel may be more than 10. A variance of a distribution of each kernel may be more than 20. A variance of a distribution of each kernel may be more than 25. A variance of a distribution of each kernel may be less than 35. A variance of a distribution of each kernel may be less than 40. A variance of a distribution of each kernel may be less than 50.

The weak supervision annotation information may indicate whether at least one predetermined organ is included in the training medical image. The at least one predetermined organ may comprise a heart.

The weak supervision annotation information for each training medical image may indicate whether at least one predetermined organ sub-structure is included in the training medical image. The at least one organ sub-structure may comprise a left ventricle of the heart. The at least one organ sub-structure may comprise a right ventricle of the heart. The at least one organ sub-structure may comprise a myocardium of the heart.

The weak supervision annotation information for each training medical image may comprise a volume of the at least one predetermined organ. The weak supervision annotation information for each training medical image may comprise a volume of a predetermined sub-structure of the at least one predetermined organ.

The weak supervision annotation information for each training medical image may comprise bounding information representative of a boundary of the at least one predetermined organ. The weak supervision annotation information for each training medical image may comprise bounding information representative of a boundary of a predetermined sub-structure of the at least one predetermined organ. The weak supervision annotation information for each training medical image may comprise a bounding box for the at least one predetermined organ. The weak supervision annotation information for each training medical image may comprise a bounding box for at least one predetermined sub-structure of the at least one predetermined organ.

The weak supervision annotation information may further comprise information relating to at least one pathology. The weak supervision annotation information may further comprise information relating to at least one medical device.

The task may comprise segmentation. The segmentation may comprise a segmentation of the at least one predetermined organ. The segmentation may comprise a segmentation of the at least one predetermined sub-structure of the at least one predetermined organ. The segmentation may comprise a segmentation of at least one pathology. The segmentation may comprise a segmentation of at least one medical device.

The task may comprise registration. The task may comprise regression. The task may comprise image translation. The image translation may comprise translating an image having a first style that is characteristic of a first imaging modality to an image having a second, different style that is characteristic of a second, different imaging modality.

The weak supervision annotation information may be further used to provide weak supervision to an output of the task.

The deep learning network may further comprise a feature encoder. The deep learning network may further comprise a task module configured to perform the task.

The processing circuitry may be further configured to augment the plurality of training medical images by transforming at least some of the training medical images using at least one augmentation transformation to obtain augmented training medical images. The training of the deep learning network may comprise using the training medical images and the augmented training medical images.

The at least one augmentation transformation may comprise scaling.

The processing circuitry may be further configured to: receive a target image and use the trained deep learning network to decompose the target image into a compositional latent representation comprising a plurality of kernels, each kernel having a respective activation. The processing circuitry may be further configured to use the kernels to perform the task and obtain a task output. The processing circuitry may be further configured to use the activations to perform the task and obtain a the task output.

In a further aspect, which may be provided independently, a method comprises: receiving a plurality of training medical images, each annotated with respective weak supervision annotation information; and using the plurality of training medical images to train a deep learning network to perform a task, wherein the training of the deep learning network comprises training a compositional latent representation comprising a plurality of kernels.

The weak supervision annotation information relates to at least one object represented in the training medical image. The at least one object may comprise at least one anatomical object. The at least one anatomical object may comprise at least one organ. The at least one anatomical object may comprise at least one organ sub-structure. The at least one object may comprise at least one pathology. The at least one object may comprise at least one medical device.

The training of the compositional latent network comprises using the weak supervision annotation information to provide weak supervision of the training of the computational latent representation. The training may thereby guide the compositional latent representation towards a representation in which different ones of the kernels are representative of different objects. The different objects may comprise at least one anatomical object. The different objects may comprise at least one pathology. The different objects may comprise at least one medical device.

In a further aspect, which may be provided independently, there is provided a medical image processing apparatus comprising: a memory configured to store a trained deep learning network; and processing circuitry configured to: receive a target image; use the trained deep learning network to decompose the target image into a compositional latent representation comprising a plurality of kernels, each kernel having a respective activation; and use the kernels and activations to perform a task and obtain a task output.

The compositional latent representation may be trained by: receiving a plurality of training medical images, each annotated with respective weak supervision annotation information relating to at least one object represented in the training medical image; and using the plurality of training medical images to train a deep learning network to perform a task, wherein the training of the deep learning network comprises training a compositional latent representation comprising a plurality of kernels, wherein the training of the compositional latent network comprises using the weak supervision annotation information to provide weak supervision of the training of the computational latent representation, thereby guiding the compositional latent representation towards a representation in which different ones of the kernels are representative of different objects. The different objects may comprise at least one anatomical object. The at least one anatomical object may comprise at least one organ. The at least one anatomical object may comprise at least one organ sub-structure. The different objects may comprise at least one pathology. The different objects may comprise at least one medical device.

The task may comprise segmentation. The activations may be used to provide the segmentation.

The task may comprise at least one of: segmentation, registration, image translation, regression.

The processing circuitry may be further configured to analyze the activations to generate an explanation of the task output.

In a further aspect, which may be provided independently, a method comprises: receiving a target image; using a trained deep learning network to decompose the target image into a compositional latent representation comprising a plurality of kernels, each kernel having a respective activation; and using the kernels and activations to perform a task and obtain a task output.

The compositional latent representation may be trained by: receiving a plurality of training medical images, each annotated with respective weak supervision annotation information relating to at least one object represented in the training medical image; and using the plurality of training medical images to train a deep learning network to perform a task, wherein the training of the deep learning network comprises training a compositional latent representation comprising a plurality of kernels, wherein the training of the compositional latent network comprises using the weak supervision annotation information to provide weak supervision of the training of the computational latent representation, thereby guiding the compositional latent representation towards a representation in which different kernels are representative of different objects. The different objects may comprise at least one anatomical object. The at least one anatomical object may comprise at least one organ. The at least one anatomical object may comprise at least one organ sub-structure. The different objects may comprise at least one pathology. The different objects may comprise at least one medical device.

In a further aspect, which may be provided independently, there is provided an apparatus for weakly supervised medical image analysis. A network contains a compositional latent representation, for example using von Mises Fisher kernels. Weak supervision is applied to guide the latent representation.

The apparatus may perform a method extending also to semi-supervised learning for equivariant tasks.

The network may contain a supervised module for an equivariant task, for example segmentation, registration, image translation.

Weak supervision about the semantic content of the image may be applied to the output of a task module.

The weak supervision might be the presence or absence of organs or organ sub-structures.

The weak supervision might be the volume of organs or organ sub-structures.

The weak supervision might be the bounding box of organs or organ sub-structures.

Data augmentations may be used to train the model, using augmentation transformations for which the relation of the weak supervision holds and the label can be correspondingly predicted, for example scaling of images (new volume & new extent of organ can be reliably predicted).

Other types of semantic medical image content may be used, for example for pathology and medical devices.

Features in one aspect or embodiment may be combined with features in any other aspect or embodiment in any appropriate combination. For example, apparatus features may be provided as method features and vice versa.

### BRIEF DESCRIPTION OF THE DRAWINGS

Embodiments are now described, by way of non-limiting example, and are illustrated in the following figures, in which:

FIG. 1 is a schematic illustration of an apparatus in accordance with an embodiment;

FIG. 2 is an illustrative overview of representation learning as is known in the art;

FIG. 3 is a schematic illustration of a low data regime for segmentation in accordance with an example embodiment;

FIG. 4 is an illustration of images, ground truth segmentation masks, and activation channels for an example medical image with no supervision;

FIG. 5 is an illustration of images, ground truth segmentation masks, and activation channels for an example medical image with weak supervision; and other figures are not numbered, are interspersed with text, and provide or illustrate further embodiments.

### DETAILED DESCRIPTION

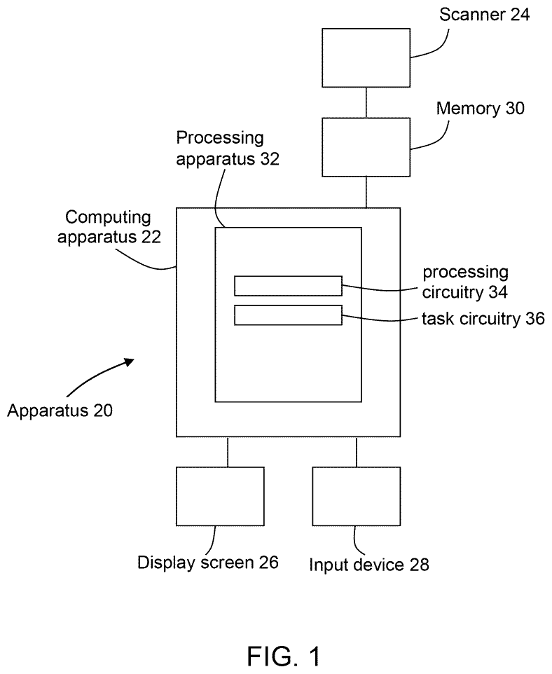

A data processing apparatus 20 according to an embodiment is illustrated schematically in FIG. 1. In the present embodiment, the data processing apparatus 20 is configured to process medical image data. In other embodiments, the data processing apparatus may be configured to process any other appropriate image data.

The data processing apparatus 20 comprises a computing apparatus 22, which in this case is a personal computer (PC) or workstation. The computing apparatus 22 is connected to a display screen 26 or other display device, and an input device or devices 28, such as a computer keyboard and mouse.

The computing apparatus 22 is configured to obtain data sets from a memory 30. At least some of the data obtained from the memory comprises medical imaging data, for instance data obtained using a scanner 24. The medical image data may comprise two-, three- or four-dimensional data in any imaging modality. For example, the scanner 24 may comprise a magnetic resonance (MR or MRI) scanner, CT (computed tomography) scanner, cone-beam CT scanner, X-ray scanner, ultrasound scanner, PET (positron emission tomography) scanner or SPECT (single photon emission computed tomography) scanner.

The computing apparatus 22 may receive data from one or more further data stores (not shown) instead of or in addition to memory 30. For example, the computing apparatus 22 may receive medical image data from one or more remote data stores (not shown) which may form part of a Picture Archiving and Communication System (PACS) or other information system.

Computing apparatus 22 provides a processing resource for automatically or semi-automatically processing the data. Computing apparatus 22 comprises a processing apparatus 32. The processing apparatus 32 comprises processing circuitry 34 configured to train a deep learning network; and task circuitry 36 configured to use the trained deep learning network to perform a task.

In the present embodiment, the circuitries 34, 36 are each implemented in computing apparatus 22 by means of a computer program having computer-readable instructions that are executable to perform the method of the embodiment. However, in other embodiments, the various circuitries may be implemented as one or more ASICs (application specific integrated circuits) or FPGAs (field programmable gate arrays).

The computing apparatus 22 also includes a hard drive and other components of a PC including RAM, ROM, a data bus, an operating system including various device drivers, and hardware devices including a graphics card. Such components are not shown in FIG. 1 for clarity.

The data processing apparatus 20 of FIG. 1 is configured to perform methods as illustrated and/or described in the following.

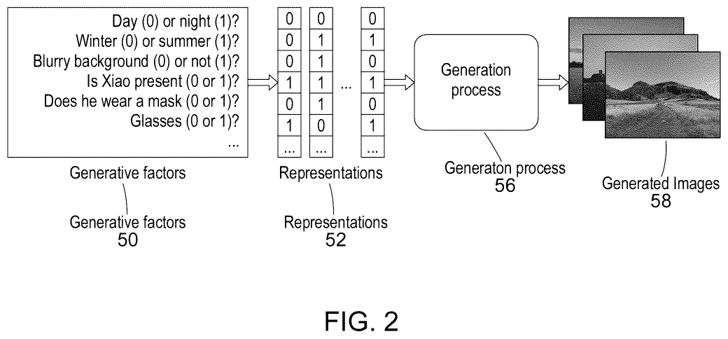

FIG. 2 shows an illustrative overview of representation learning as is known in the art. In representation learning it is assumed that data e.g. generated images 58 are generated by a generation process 56 using representations 52 based on a plurality of underlying generative factors 50 (e.g. the presence, colour, size or the like of particular features of the generated images 58). Given the data (e.g. the plurality of generated images 58), the aim of representation learning is to train a deep learning model to identify the generation process 56 and representations 52 provided to the generation process 56 in order to generate the data. This technique can be applied to medical imaging as will be described below.

Compositional representations satisfy the following equation:

$${F}_{ψ} ( S ∘ X ) = S ∘ {F}_{ψ} ( X )$$

where S∘ denotes the separation operation. If the representation of the separated generative factor in X is equivalent to the separated representation of X using the same separation operation, then the representation S∘F_{ψ}(X) is compositional. For example, the separation operation can be masking the image with the masks of objects. Typically, designing such separation operations requires knowing the ground truth generative factors.

Equivariance is defined as:

$${F}_{ψ} ( {M}_{g} \cdot X ) = {M}_{g} \cdot {F}_{ψ} ( X )$$

where Mg denotes a set of transformations. Here, F_{ψ}(X) is equivariant if there exists Mg such that the transformations of the input X that transform the output F_{ψ} (X) in the same manner. A compositionally equivariant representation is therefore defined as satisfying:

$${F}_{ψ} ( {M}_{g} \cdot S ∘ X ) = {M}_{g} \cdot S ∘ {F}_{ψ} ( X ) .$$

Good representations should be compositionally equivariant. In order to learn compositionally equivariant representations, image features are first decomposed into learnable kernels (e.g. von Mises Fisher (vMF) kernels). For each kernel, the activation channel can be obtained. The activations of the kernels are spatially informative and thus can be used for downstream segmentation. The more compositionally equivariant the kernels are, the better the segmentation performance is. This decomposition has previously been used for object detection under occlusion and medical image segmentation.

For an example cardiac image segmentation task, which is typically used to help diagnose, treat, manage, prevent, and predict cardiovascular disease, 12 kernels are used to perform the decomposition. The variance σ of the distribution is fixed to 30 for all the kernels (empirically selected). Without further constraints, the kernels may not be compositionally equivariant. In other words, the kernels may not correspond to human-interpretable semantic information. To improve the compositional equivariance, three forms of weak supervision are proposed. As such, good representations (e.g. image features) for the task of segmentation can be learned with minimal supervision which dramatically improves performance, in particular reducing the time and expense of fully annotating the segmentation masks.

Finding good latent representations for a particular task is fundamental in machine learning. When supervision is available for the latent representations (the ground truth generative factors) and the downstream task (the ground truth labels), it is natural to train the model with supervised losses. However, in practice, it is common that not all the generative factors of the data are known. When there is insufficient supervision for either the latent representations or the downstream task, learning generalisable and interpretable representations can be challenging. To tackle this issue, compositional equivariance can be used as an inductive bias to learn the latent representations. With compositional equivariance, it is possible to learn the desired representations with weak supervision.

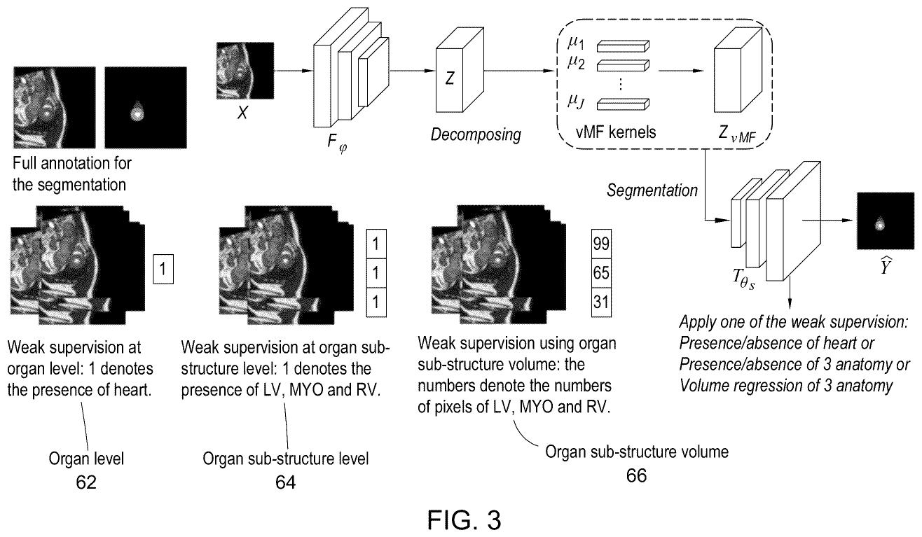

FIG. 3 schematically illustrates a low data regime for segmentation in accordance with an example embodiment. The regime uses one fully annotated patient 60 with segmentation masks, whereby approximately twenty labeled two-dimensional (2D) images are supplied. In addition, around 5000 ‘weakly labeled’ 2D images are also supplied. The annotation of the weakly labelled images comprises information representative of the boundary of an object of interest (e.g. a boundary box) but any other suitable form of annotation may be used. The aim is to train a segmentation model which has good performance on all of the images. In order to achieve this, different weak supervision objectives are constructed i.e. presence/absence of heart 62, presence/absence of left ventricle (LV), myocardium (MYO) and right ventricle (RV) 64 and volume regression of LV, MYO and RV 66. However, the objectives may additionally/alternatively include the presence, absence and/or volume of any other anatomical object (e.g. organ, organ sub-structure or the like), pathology or medical device of interest. Weak supervision with compositional equivariance can then be used to learn compositionally equivariant representations for this segmentation task (or additionally/alternatively for a registration, image translation or regression task).

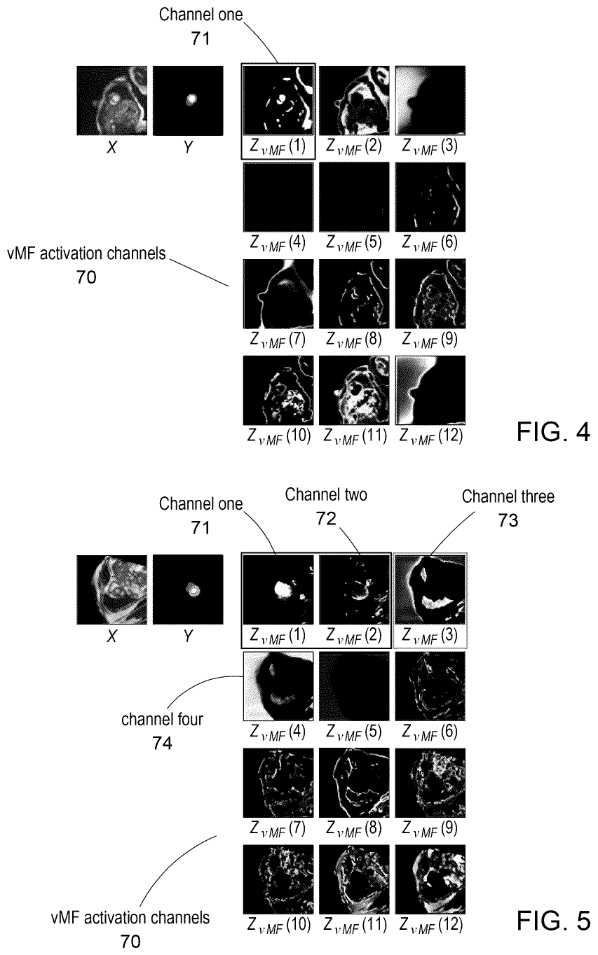

FIGS. 4 and 5 illustrate the effect of using weak supervision on compositional equivariance. In FIGS. 4 and 5 twelve vMF activation channels 70 are shown for two examples, with (FIG. 5) and without (FIG. 4) weak supervision applied. It is clearly shown that stronger compositional equivariance is observed with weak supervision as illustrated in FIG. 5 when compared to the unsupervised setting of FIG. 4. With weak supervision, Channels one 71 and two 72 of FIG. 5 are more related to the heart. Channel three 73 of FIG. 5 shows the shape of the lungs despite no supervision being provided for that particular task. Channel four 74 of FIG. 5 contains mostly the background of the input image. Overall, the activations of the compositional representations are more interpretable, and each channel is more homologous i.e. more compositionally equivariant in FIG. 5 than in FIG. 4. For the weakly supervised regime as shown in FIG. 5, it is observed that one compositional representation 73 represents the lungs even though no information about the lungs is provided to the model.

Considering the task of heart segmentation with weak supervision (presence/absence of heart) and using the best-fit kernel activation as the heart segmentation as shown in FIG. 5 the following results are observed:

| | | Weakly supervised |
|---|---|---|
| Heart segmentation | Unsupervised | (presence/absence of heart) |
| Training data | 18.05 | 35.44 |
| Test data | 10.25 | 34.81 |

As is shown, overall weak supervision helps with heart segmentation even though no segmentation masks are provided during training.

Considering the low data regime described above with reference to FIG. 3, and employing different weak supervision objectives for four labelled subjects A, B, C and D, the following results are observed which demonstrate the effectiveness of the weak supervision objectives:

| Labeled | | Dice + Heart | Dice + 3 Anatomy | Dice + 3 |
|---|---|---|---|---|
| Subject | Dice | or Not | or Not | Volumes |
| A | 54.41 | 57.92 | 54.61 | 55.03 |
| B | 45.47 | 35.41 | 49.34 | 48.87 |
| C | 40.41 | 41.87 | 49.00 | 46.27 |
| D | 46.36 | 41.62 | 44.93 | 50.39 |
| Average | 46.66 | 44.21 | 49.47 | 50.14 |
| Improvement | ~ | −5.5% | 6.02% | 7.5% |

As is shown above when weak supervision objectives are not employed (the “Dice” case in the table above), on average a Dice score of approximately 46.66 is achieved. When weak supervision of presence/absence of heart is introduced (“Dice+Heart or Not”), better results are achieved in some cases (although on average there is no improvement). In this example with the other two weak supervision objectives, on average around 6% and 7.5% improvements are achieved.

In use, the weakly-supervised compositionally equivariant representation learning described throughout this disclosure can be used, for example, to improve medical image segmentation performance when there are no extensive annotations.

Using weak supervision (as described above), more compositionally equivariant representations can be learnt resulting in better cardiac image segmentation results being achieved. This provides accurate and automatic medical image segmentation without the need for extensive annotations. As previously shown (for example see Liu, X. et al., 2022. vMFNet: Compositionality Meets Domain-Generalised Segmentation. MICCAI) learning compositional kernels for the task of medical image segmentation addresses the domain shifts between source domains and unknown target domains. This beneficial generalisation ability is maintained by the weakly supervised compositionally equivariant representations described herein.

The weakly-supervised compositionally equivariant representation learning described throughout this disclosure can also be used improve the explainability of medical image segmentation models. The activation of each kernel corresponds to the presence/absence of a particular anatomy. For example, if a kernel is compositionally equivariant and carries information about a particular anatomical organ, then when this kernel is activated, the presence of the organ, or otherwise, can be predicted. If the model does not accurately predict the correct result, the activations of the kernels can be interrogated to diagnose and improve model performance.

In addition to training the deep learning model/network, processing circuitry (such as the processing circuitry 34 of FIG. 1) may augment at least some of the training medical images (e.g. by scaling to present a different volume and/or extent of the object of interest) to produce augmented training medical images. Said augmented training medical images can then be additionally/alternatively used to train the deep learning model/network.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Experimentally obtained results of an embodiment of the invention are now described, the results of which are presented in tables I to IV and FIGS. 4 to 8 of Liu et al [Liu, X., Sanchez, P., Thermos, S., O'Neil, A. Tsaftaris, S. 2023. “Compositionally Equivariant Representation Learning”. arXiv: 2306.07783] which is hereby incorporated by reference in its entirety.

The following datasets were used in the described experiments.

The “multi-centre, multi-vendor & multi-disease cardiac image segmentation” (M&Ms) dataset consists of 320 subjects, scanned at six clinical centres, using four different magnetic resonance scanner vendors (hereinafter referred to as domains A, B, C and D). For each subject, only the end-systole and end-diastole phases were annotated. The voxel resolutions of this dataset range from 0.85×0.85×10 mm to 1.45×1.45×9.9 mm. Domain A contained 95 subjects, domain B contained 125 subjects, and domains C and D each contained 50 subjects.

The “spinal cord gray matter segmentation” (SCGM) dataset images were collected from four different medical centres with different MRI systems (hereinafter referred to as domains 1, 2, 3 and 4). The voxel resolutions of this dataset range from 0.25×0.25×2.5 mm to 0.5×0.5×5 mm. Each domain has ten labelled subjects and ten unlabeled subjects.

In the experiments all models were trained using the Adam optimiser with a learning rate of 1×e⁻⁴ for 50K iterations using a batch size of 4 for the semi-supervised settings. Images were cropped to 288×288 for M&Ms dataset and 144×144 for the SCGM dataset. F_{ψ} is a 2D U-Net encoder without the last up sampling and output layers to extract features Z, however F_{ψ} can be replaced by other suitable encoders such as a ResNet and the feature vectors can alternatively be extracted from any layer of the encoder. As will be appreciated by those skilled in the art performance may vary depending on the layer or layers used. For all settings, the U-Net was pre-trained for 50 epochs with unlabeled data from the source domains.

For the weakly supervised setting, the classifier T_{θ} has 5 CONV-BN-LeakyReLU layers (kernel size 4, stride size 2 and padding size 1) and two fully-connected layers that down-sample the features to 16 dimensions and 1 dimension (for output). For the semi-supervised settings, T_{θ} and R_{ω} have similar structures, where a double CONV layer (kernel size 3, stride size 1 and padding size 1) in U-Net with batch normalisation and ReLU was first used to process the features. Then a transposed convolutional layer was used to up sample the features followed by a double CONV layer with batch normalisation and ReLU. Finally, an output convolutional layer with 1×1 kernels was used.

For T_{θ}, the output of the last layer was processed with a sigmoid operation. The variance of the vMF distributions was set to 30 and the number of kernels was set to 12. This number of Kernels was selected as it was found empirically in early experiments that this number provided the best result. As will be appreciated by those skilled in the art, for different medical datasets, the optimum number of kernels may be slightly different. All models are implemented in PyTorch and are trained using an NVIDIA 2080 Ti GPU.

In semi-supervised settings, specific percentages of the subjects were used as labelled data and the rest were used as unlabeled data. The models were trained with three of the source domains, with the fourth source domain treated as the target domain. Dice (expressed as %) and Hausdorff Distance (HD) were used as the evaluation metrics.

The generative factors should be generalisable and human-understandable. Therefore, in order to evaluate compositional equivariance, the interpretability and generalisation ability of the activations of the compositionally equivariant representations were considered. For interpretability, it was considered how much each vMF activation channel was meaningful (i.e. carries information that is relevant to specific anatomy) and how homologous each channel was. For generalisation ability, the performance of the model on the task of semi-supervised domain generalisation was considered.

For the unsupervised setting the model was trained for 200 epochs with all the labelled data of the M&Ms dataset. The qualitative results from this setting are shown in FIG. 4 of Liu et al. With only the clustering loss, some channels are already meaningful i.e. corresponding to specific anatomy.

For the weakly supervised setting the model was trained for 200 epochs with all the labelled data of M&Ms dataset. The qualitative results of this setting are shown in FIG. 5 of Liu et al. It is clearly shown that a stronger compositional equivariance is achieved compared to the unsupervised setting. Overall, the activations of the compositional representations are more interpretable and each channel is more homologous i.e. more compositionally equivariant.

It is noted that for both unsupervised and weakly supervised settings, it was observed that one compositional representation represents the lungs even though no information about the lungs was provided. This means that the learnt representations are ready to be used for lung localisation/segmentation when a small amount of relevant labelled data is made available.

For the semi-supervised settings, the methods were tested against other available models on semi-supervised domain generalisation problems. In order to achieve meaningful results, all models were compared with the same backbone feature extractor, i.e. UNet, without any pre-training on other datasets.

Tables I to III of Liu et al. shows results in the semi-supervised setting with weak supervision. For weak supervision, weak labels for the end-systole and end-diastole phases of the 320 subjects of the M&Ms dataset were constructed. It is noted that the weak supervision does not apply to SCGM data as the gray matter usually exists in every slice and therefore no meaningful results would be produced.

It is shown that vMFWeak has the same advantage on training speed as vMFNet, where one epoch of training takes around 8 minutes. It was observed that vMFWeak similarly outperformed DGNet with 3.9% and 2.1% improvements (in Dice) for 2% and 5% cases on the M&Ms dataset. Compared to vMFNet and vMFPesudo, vMFWeak only leverages part of the unlabeled data i.e. the end-systole and end-diastole phases, causing slightly worse performance on the 2% and 5% cases. However, for certain cases, vMFWeak still outperforms the other models indicating the effectiveness of the weak supervision.

As shown in FIG. 8 of Liu et al., channels 1 to 3 correspond to LV, RV and MYO. Due to the constraint of weak supervision, the model is forced to learn a more compact latent space, where most of the information that is irrelevant to the segmentation and weak supervision task is eliminated. Overall, eminently interpretable, and homologous representations can still be obtained using weak supervision.

Whilst certain embodiments are described, these embodiments have been presented by way of example only, and are not intended to limit the scope of the invention. Indeed, the novel methods and systems described herein may be embodied in a variety of other forms. Furthermore, various omissions, substitutions, and changes in the form of the methods and systems described herein may be made without departing from the spirit of the invention. The accompanying claims and their equivalents are intended to cover such forms and modifications as would fall within the scope of the invention.

1. A medical image processing apparatus comprising:
a memory storing a plurality of training medical images, each annotated with respective weak supervision annotation information relating to at least one object represented in the training medical image, the at least one object comprising an anatomical object, a pathology, or a medical device; and
processing circuitry configured to use the plurality of training medical images to train a deep learning network to perform a task, wherein the training of the deep learning network comprises training a compositional latent representation comprising a plurality of kernels,
wherein the training of the compositional latent network comprises using the weak supervision annotation information to provide weak supervision of the training of the computational latent representation, thereby guiding the compositional latent representation towards a representation in which different ones of the kernels are representative of different objects, the different objects comprising at least one anatomical object, pathology, or medical device.

2. A medical image processing apparatus according to claim 1, wherein the kernels are von Mises Fisher kernels.

3. A medical image processing apparatus according to claim 1, wherein the weak supervision annotation information indicates whether at least one predetermined organ is included in the training medical image.

4. A medical image processing apparatus according to claim 3, wherein the at least one predetermined organ comprises a heart.

5. A medical image processing apparatus according to claim 3, wherein the weak supervision annotation information for each training medical image indicates whether at least one predetermined organ sub-structure is included in the training medical image.

6. A medical image processing apparatus according to claim 3, wherein the weak supervision annotation information for each training medical image comprises at least one of: a volume of the at least one predetermined organ, a volume of a predetermined sub-structure of the at least one predetermined organ.

7. A medical image processing apparatus according to claim 3, wherein the weak supervision annotation information for each training medical image comprises at least one of: bounding information representative of a boundary of the at least one predetermined organ; bounding information representative of a boundary of a predetermined sub-structure of the at least one predetermined organ, a bounding box for the at least one predetermined organ, a bounding box for at least one predetermined sub-structure of the at least one predetermined organ.

8. A medical image processing apparatus according to claim 1, wherein the weak supervision annotation further comprises information relating to at least one pathology.

9. A medical image processing apparatus according to claim 1, wherein the weak supervision annotation further comprises information relating to at least one medical device.

10. A medical image processing apparatus according to claim 1, wherein the task comprises at least one of: segmentation, registration, image translation, regression.

11. A medical image processing apparatus according to claim 1, wherein the weak supervision annotation information is further used to provide weak supervision to an output of the task.

12. A medical image processing apparatus according to claim 1, wherein the processing circuitry is further configured to augment the plurality of training medical images by transforming at least some of the training medical images using at least one augmentation transformation to obtain augmented training medical images; and wherein the training of the deep learning network comprises using the training medical images and the augmented training medical images.

13. A medical image processing apparatus according to claim 12, wherein the at least one augmentation transformation comprises scaling.

14. A medical image processing apparatus according to claim 1, wherein the processing circuitry is further configured to:
receive a target image;
use the trained deep learning network to decompose the target image into a compositional latent representation comprising a plurality of kernels, each kernel having a respective activation; and
use the kernels and activations to perform the task and obtain a task output.

15. A method comprising:
receiving a plurality of training medical images, each annotated with respective weak supervision annotation information relating to at least one object represented in the training medical image, the at least one object comprising an anatomical object, a pathology or a medical device; and
using the plurality of training medical images to train a deep learning network to perform a task, wherein the training of the deep learning network comprises training a compositional latent representation comprising a plurality of kernels,
wherein the training of the compositional latent network comprises using the weak supervision annotation information to provide weak supervision of the training of the computational latent representation, thereby guiding the compositional latent representation towards a representation in which different ones of the kernels are representative of different objects, the different objects comprising at least one anatomical object, pathology, or medical device.

16. A medical image processing apparatus comprising:
a memory configured to store a trained deep learning network; and
processing circuitry configured to:
receive a target image;
use the trained deep learning network to decompose the target image into a compositional latent representation comprising a plurality of kernels, each kernel having a respective activation; and
use the kernels and activations to perform a task and obtain a task output,
wherein the compositional latent representation is trained by:
receiving a plurality of training medical images, each annotated with respective weak supervision annotation information relating to at least one object represented in the training medical image, the at least one object comprising an anatomical object, a pathology, or a medical device; and
using the plurality of training medical images to train a deep learning network to perform a task, wherein the training of the deep learning network comprises training a compositional latent representation comprising a plurality of kernels,
wherein the training of the compositional latent network comprises using the weak supervision annotation information to provide weak supervision of the training of the computational latent representation, thereby guiding the compositional latent representation towards a representation in which different ones of the kernels are representative of different objects, the different objects comprising at least one anatomical object, pathology or medical device.

17. A medical image processing apparatus according to claim 14, wherein the task comprises segmentation, and wherein the activations are used to provide the segmentation.

18. A medical image processing apparatus according to claim 14, wherein the task comprises at least one of: segmentation, registration, image translation, regression.

19. A medical image processing apparatus according to claim 14, wherein the processing circuitry is further configured to analyse the activations to generate an explanation of the task output.

20. A method comprising:
receiving a target image;
using a trained deep learning network to decompose the target image into a compositional latent representation comprising a plurality of kernels, each kernel having a respective activation; and
using the kernels and activations to perform a task and obtain a task output,
wherein the compositional latent representation is trained by:
receiving a plurality of training medical images, each annotated with respective weak supervision annotation information relating to at least one object represented in the training medical image, the at least one object comprising an anatomical object, a pathology, or a medical device; and
using the plurality of training medical images to train a deep learning network to perform a task, wherein the training of the deep learning network comprises training a compositional latent representation comprising a plurality of kernels,
wherein the training of the compositional latent network comprises using the weak supervision annotation information to provide weak supervision of the training of the computational latent representation, thereby guiding the compositional latent representation towards a representation in which different kernels are representative of different objects, the different objects comprising at least one anatomical object, pathology, or medical device.
